(19) United States
(12) Patent Application Publication
(10) Pub. No.: US 2015/0081332 A1
(43) Pub. Date: Mar. 19, 2015

(54) Method for Indexing, Searching and Retrieving Health Information

(71) Applicants: Joe Casper, Irving, TX (US); Terry Shackelford, Irving, TX (US); Derek Plansky, Irving, TX (US); Paul Steinichen, Irving, TX (US)

(72) Inventors: Joe Casper, Irving, TX (US); Terry Shackelford, Irving, TX (US); Derek Plansky, Irving, TX (US); Paul Steinichen, Irving, TX (US)

(21) Appl. No.: 14/470,204

(22) Filed: Aug. 27, 2014

Related U.S. Application Data
(60) Provisional application No. 61/872,112, filed on Aug. 30, 2013.

(51) Int. Cl. G06F 19/00; G06F 17/30

(52) U.S. Cl. CPC G06F 19/322; G06F 17/30569
USPC 705/3

(57) ABSTRACT

A medical information delivery system and method for indexing, searching and retrieving health information, increasing patient treatment and satisfaction and improving efficiency and care provided by physicians. Medical information from varied platforms, medical institutions and sources is normalized and integrated into the system without the need for specially-designed software or user platforms. The system measures patient health, enabling doctors to quickly identify gaps in quality of health care. Various notifications are delivered to users indicating gaps in care, post-treatment care, and other treatment options for the patient. Once action is taken on prioritized notification, it is hidden. As users take actions and make notes, the electronic health record is automatically updated and the system immediately incorporates the most recent information. The system allows tracking of at-risk patients who have not received proper care and retrospectively monitors performance and treatment of patients to identify cost controlling measures for most expensive patients.

### CROSS-REFERENCE TO RELATED APPLICATIONS

This application claims the benefit under 35 U.S.C. §119(e) of U.S. Provisional Patent Application No. 61/872,112, which was filed on the 30 Aug. 2013.

### TECHNICAL FIELD

The present invention is generally a system and method of indexing, searching, alerting and retrieving patient health information.

### BACKGROUND

U.S. Patent Application Publications

| Patent No | Kind Code | Issue Date | Patentee |
|---|---|---|---|
| US 7953699 | B2 | May 31, 2011 | Mathur |
| Publication No. | Kind Code | Publication Date | Applicant |
| 2003/0208382. | A1 | Nov. 6, 2003 | Westfall |
| 2004/0128163 | A1 | Jul. 1, 2004 | Goodman et al. |
| 2005/0071194 | A1 | Mar. 31, 2005 | Bormann et al. |
| 2006/0229918 | A1 | Oct. 12, 2006 | Fotsch et al. |
| 2007/0162307 | A1 | Jul. 12, 2007 | Austin et al. |
| 2009/0222283 | A1 | Sep. 3, 2009 | Lassetter et al. |

The rapidly evolving field of health information technology (HIT) is transforming the healthcare system in the United States, offering new waves of integrated electronic and mobile solutions that solve some of the most challenging aspects o providing, coordinating and delivering health care in a safe, effective, and quality manner. No longer encumbered by the lumbering, fragmented system of healthcare of the past, today's health providers and caregivers are beginning to harness the potential of data and analytics with integrated health IT innovations that offer new decision frontiers, in the digital health paradigm of the 21^{st} century, health IT can help enable informed decisions at the point-of-care within the normal workflow, providing better healthcare services to patients. Customized, real-time, community wide, clinical and administrative data can be seamlessly accessed and exchanged between providers, patients, insurers, and others to improve the quality, safety, and efficiency of care delivered across the care continuum. This ability has largely been catalyzed by the passage of the American Reinvestment and Recovery Act (ARRA), which included the Health Information Technology for Economic and Clinical Health (HITECH) provisions, which provided financial incentives to encourage the adoption and use of electronic health records (EHRs) in health care practices and hospitals across the country through a series of policy levers. HITECH assisted in the acceleration of the implementation of a roadmap to improve health care outcomes at an individual and population level through the timely and secure electronic use, exchange, and reporting of health information.

This adoption of EHRs across various health care settings has led to a rich supply of localized data that holds tremendous promise to improve the efficiency and quality of patient care while reducing costs and errors. Studies have revealed that the continued use of EHRs results in the elimination of more than two million adverse drug events, the reduction of over 190,000 unnecessary hospitalizations a year and the reduction of medication processing time by 68 percent and problem medication orders by 58 percent. EHR presents costs savings for the government, medical providers and patients as well as more accurate medical treatments for patients. The avoidance of so many potentially catastrophic events will save many lives and dollars over time.

EHRs may access data from varied sources, including labs, radiology and pathology, physicians, nurses, technicians, among others in order to develop a comprehensive and accurate patient record that can be accessed at the point of care. However, access to cross healthcare organizational and community boundary data, such as acute care, behavioral health and rehabilitation, is complex and the cost of providing access to this data is often very high. As the EHRs continue to become more standard within medical environments, a system to access the data within each of the varied systems throughout a community still has not been developed. Eventually health information exchange (HIE) was developed for the electronic transmission and sharing of medical information between organizations within a locale, region, or hospital system. The system maintains the integrity of the information between transfers between varied venues and platforms.

Despite the evolution of HIE methods over the past decade, one of the most significant issues with EHRs continues to be that EHRs are often developed and installed as standalone systems that are a part of a larger health information network. An EHR can potentially support the management and coordination of care by providing accurate, complete, secure, and up-to-date information. Moreover, by recording, monitoring, and analyzing a complex combination of clinical, administrative, and claims-based data, EHRs can facilitate the reduction of medical errors and waste, improve communication, and inform better decision-making processes. However, the success of EHR is still significantly hindered by fragmented or incomplete patient records that can prevent an EHR from performing critical services, such as sending an alert when a duplicate procedure is ordered or effectively coordinating care among disparate providers. Moreover, the intense competition within communities and between EMR vendors often precludes these organizations from participating in cross community data exchange efforts. For example, patient data maintained in a local clinic, from the city hospital or a local laboratory, may not be on the same or compatible platforms. Additionally, many EHRs cannot communicate with other EHRs, or otherwise fail to fully integrate with an HIE. The various patient data also may not be accessible or available to later care providers. Medical personnel are forced to go through the red tape of obtaining a patient's prior medical history or records. Or a physician may depend on the memory of the patient regarding previous diagnoses and/or treatment. Without interoperable systems that are capable of filling in the digital gaps of a patient's longitudinal medical history, the efficacy of health providers can be limited by disparate technologies amongst healthcare providers. This becomes a critical deficiency to measure quality within a healthcare organization, which is one of the principal foundations of the meaningful use program.

An accountable care organization (ACO) consists of a provider group that accepts responsibility for the cost and quality of care delivered to a specific population of patients, using self-reported data to assess performance. The formation of an ACO has the potential to significantly benefit patients, particularly through care coordination, more efficient care processes, performance measurement and quality improvement. The capabilities of an EHR system are rendered moot if an ACO is unable to access and share real-time (or near real-time) patient data. This model of care delivery, the ACO, becomes vital in today's era of healthcare. For example, patients with chronic illnesses are more likely to see multiple providers to manage their conditions, so there is a significant need for the health care delivery system to manage patient care across disparate settings and providers over time.

Under the current system, information may often be missing at a given point-of-care, and knowledge about the patient's condition is rarely shared among those caring for the patient. When information is shared between providers, it is frequently incomplete, late or missing, resulting in delays in appropriate treatment, repetition of tests and procedures, and overall inconvenience. ACOs create healthcare teams that act as “receptors” of information from EHRs, who can turn the information into a comprehensive strategy to treat or manage a patient's condition. Therefore, aggregating the data from multiple EHR systems, in near real-time, to view entire communities will provide a complete, patient-centered view of each individual's healthcare data. Access to results of treatments for similar conditions among individuals will allow for the development of better evidence-based care protocols. The full mobility and availability of a patient-centric view of an individual's healthcare data can lead to better care coordination and more effective care management for both individuals and entire communities. Professionals in the field developed a new model of health information exchange (HIE) as a comprehensive and integrated solution for both clinical and financial information to reduce the chaos caused by EHR.

Meaningful Use is the set of standards from the Centers for Medicare and Medicaid Services (CMS) Incentive Programs that govern the use of electronic health records and allow eligible providers and hospitals to earn incentive payment by meeting specific criteria. The benefits of Meaningful Use are complete and accurate information available to healthcare providers, greater and easier access to the complete and accurate patient information, and the empowerment of patients to be proactive in improving and maintaining their health. However, the development of a network that embraces the diverse EHR solutions to harness the full potential of digitized data and realize the promise of analytics has been greatly frustrated and hindered by the overall lack of availability and mobility of both clinical and financial information between competing organizations. Thus, the power of predictive modeling, clinical decision support, population management, and more has been forestalled except for in areas that have managed to provide integration between competing organizations. Without pre-existing uniform standards, protocols, or guidelines for interoperability in place, a number of adopters have diverged in their approaches. As a result, most EHRs today are unilateral and not transferable. Most current EHRs are unable to send and receive information across transitions of care or facilitate query-based exchanges unless customized solutions have been coded at the community, regional, and/or state levels. The time and expense involved in creating such a code or program would be detrimental to the progress and development of the evolving EHR systems.

### SUMMARY OF THE INVENTION

The present invention enables users to locate and search patient information, patient medical records, physician records, summaries and notes associated with each patient, across multiple EHR systems (inside and outside the user's platform) and provide medical professionals real-time information associated with each patient (including the patient's electronic health record) without regard to the healthcare provider or the platform used to collect and store the data. The present invention is capable of coordinating patient care across disparate settings by aggregating health information for a master patient index and HIE (Connect); storing data in warehouses to be shared through HIE and accessed via EHR or physician portal (Dimensions); supporting population health management (Care Manager); and implementing prospective and retrospective predictive analytics (Metrix). The present system uses operating level access to gather information from the EMR application without use of a formal application programming interface (API or source code based interface to allow software components to communicate with each other) or software development kit (SDK or software development tools that allow for the creation of applications for certain platforms and systems).

The present invention allows healthcare providers easy access to patient information from a variety of information sources and formats, including those outside the user's present platform. The present invention operates in a secure cloud-computing environment that links physicians and specialists across care settings and practice locations, resulting in lower costs, higher quality and more coordinated care for the benefit of the patient and the entire healthcare system. The present system provides real time, up to date medical information, which is derived from aggregate patient data. The aggregated data may be obtained by a medical professional, for a specific patient, at the point of care during the patient visit. The present system is able to provide this aggregate data without any formal application programming interfaces or software development kits, which increases the present system's utility across various platforms and systems.

The HIE establishes electronic connections with varied Health information Technology (HIT) systems such as EHR, EMR, and HIS. These systems communicate with the HIE through a variety of standards and protocols to transfer patient information d associated clinical data. The HIE transfers the demographic data to a master patient index to accurately link patient data from across disparate systems to ensure clinical data from different systems is connected to the appropriate patient's virtual records. This patient virtual record, derived from aggregate patient data, is then stored within the HIE for later access by users of the system. The system collates post payment claims information against aggregated Master Person Index (MPI) IDs in order to aggregate person specific administrative, post payment claim, and clinical information in a longitudinal view (Dimensions). The system also supports broader care management strategy and population health management by identifying gaps in care and other key, point-of-care information, quickly and in real time so that a physician, nurse, or other caregiver will be notified while the patient is in the office or exam room.

Care givers are already accustomed to using patient folders or files to transport and maintain paper patient records. The present system and method expands the concept of the paper patient file to an electronic or digital envelope for the delivery of the targeted information at the point of care. This digital envelope can be accessed by medical professionals in any location, as long as they have access to cloud computing. This envelope may contain contextually aware information about the patient that the care giver is currently viewing in real time. It can also be delivered in a highly secure manner to the various care givers. Within the clinician's workflow, providers not only have access to a patient's full electronic health record (EHR), they also receive timely prompts from the HIE for appropriate interventions, education and follow-up, leading to a more comprehensive diagnosis and care during a single visit. Patient identity and health records are normalized through a master patient index, which uses stochastic and deterministic algorithms to link patient data from multiple sources. Patient clinical data is also normalized through one or more terminologies to standardize the data. If the data is not standardized, the system will perform standardization when the clinical system is connected to the HIE. Additionally, post payment claims and billing/administrative information are also available through the system to inform on specific contractual obligations, and/or ongoing quality initiatives.

In order to standardize patient data, the present system may use well-known normalizing systems such as International Classes of Disease (ICD-9 and ICD-10), LOINC, RxNorm and SNOMED to normalize data delivered to and from the present system prior to analysis and storage. The present system recognizes a value based on its origin such that its native as well as derived reading are both stored in the data warehouse LOINC (Logical Observation Identifiers Names and Codes) is a database and universal standard for identifying medical laboratory observations and normalizing that data for the clinical care of patients and management of EHRs. LOINC creates universal code names and unique identifiers for common medical terminology related to EHRs. RxNorm is a program that normalizes names and provides unique identifiers for all medications available in the US market and may be used in personal health record applications, pharmacy management, and drug interaction software. SNOMED (Systemized Nomenclature of Medicine) is a collection of medical terms which creates and allows a way to index, store, retrieve, and aggregate medical data across platforms. This normalized data from a variety of platforms is stored in a database to be continually accessed by the present system and method.

The present invention makes patient medical data an asset that is manageable, accessible, actionable, and valuable. Through a secure electronic data container, a message or digital request is protected through encryption and data authentication. An alert agent, or software present on the same computer as the electronic medical records (EMR), sends a notification to the alert broker, a system that receives notice from alert agent to check for information related to a patient and/or physician context. The digital request for patient data is sent to various entities through multiple HIE and EMR. The response to the digital request is integrated with then current clinician workflow by presenting item(s). If there are multiple alerts, those alerts will be prioritized once downloaded to the alert agent. The alert agent will present the alerts in priority order to the user. Once that alert is resolved, the alert agent would address the next highest alert until all alerts were resolved. In this embodiment, there are a number of alerts but it is to be understood that the system could be used for an infinite variety of alerts besides those enumerated herein. The present system includes, but is not limited to, alerts for gaps in care, care instructions, patient consent forms, and physician notifications.

The revised and updated workflow is displayed to the clinician to be acted upon and integrated into the patient treatment. To illustrate the basic flow of envelope delivery, a physician is generally notified in their local EHR once information has been gathered from the database using the present invention. The present invention directs the data container to the physician's computer where the physician may search for the patient within the EHR. Through the present system and method, the physician is notified via digital envelope containing either a message or symbol that relevant patient information is available and, upon review of the relevant information, the present system and method returns to a ready state, waiting for the next patient information to be processed.

Further, the present invention consists of four basic categories: the Health information Exchange, Data Warehouse, Data and Analytics Toolset, and the Care Management Tools. The Health Information Exchange, or data collection system, builds a comprehensive medical record including diagnoses, medications and allergies, enables medical document sharing and provides a complete patient medical record at the point-of-care with one source to view a full patient profile, and collects patient data from all connected data services and completes patient matching almost automatically providing quick connection to source systems. The HIE of the present system results in reduced time for patient data clearing, lower administrative costs and improved patient safety by lowering the frequency of patient misidentification and medication errors.

The Data Warehouse, or data normalization system, receives, parses and sorts clinical claim and administrative information from a variety of sources and in various forms and formats. The Data Warehouse uses an innovative data segmentation method to assign English language rules to computable data in order to segment data into analytic sets. The Data Warehouse uses an innovative electronic notice directly delivered to the computer then servicing the patient to inform clinicians of newly available patient data. The notice provides real-time reporting on patient quality of care at the point of care directly to a computer used by the physician while treating the patient. It stores disintegrated data so that physicians can access the specific data they need to deliver evidence-based medicine and provide high quality care management for their patients.

The Data and Analytics Toolset, or data analysis system, prospectively tracks at-risk patients falling outside quality measures and delivers notifications at the point of care, which is then integrated into the physician's EHR workflow. With this knowledge delivered in the workflow of the physician's office, doctors can take immediate action, such as scheduling a diagnostic test, ordering a procedure, e-prescribing medications or ordering a laboratory test. Gaps in care may be identified through the comparison of normalized data and patient electronic health records with established and accepted medical rule sets. Once a gap in care is recognized, the system will direct the user how to resolve the issue for a particular patient. The user may add notes to the patient electronic file or indicate that a recommended action has been taken. These updated patient files will automatically be entered into the community medical records within the HIE or MIDS. The system also retrospectively monitors caregiver performance through HEDIS, PQRS, Meaningful Use, ACO and other pay-for-performance measures. For instance, the system identifies gaps in care by perusing population data for a particular type of patient (e.g., diabetes, hypertension, over 65 years of age, etc. . . . ) and determines if the medical care received meets or complies with the standards for best practice for that ailment or condition (e.g., quarterly blood glucose tests, blood pressure measurements, colorectal screening every ten years, etc. . . . ). The present invention provides rule building functionality to interpret and report on CMS and other required measures.

The Care Management Tool, or data management system, features integrated workflow among caregivers and leverages clinical and claims information for a community view of data. This data management tool provides real time information highlighting required actions and inventions for particular patients. Patient gaps in care and patient-specific task list are generated and presented to the user.

The present invention is a centrally-deployed, computer-based system and method that may be coupled with an HIE system or other like device. This system and method of the present invention uses a secure TCPIP-based local area network (LAN), wide area network (WAN) or the Internet, to acquire, analyze, index, search and retrieve all medically relevant facts from multiple HIE systems based on a clinician's usual and customary input on the clinician's own patient data-logging device. The system can analyze data regardless of the platform or data device used for collection and regardless of where the caregiver is located. The cloud-deployed invention has various features that will increase the efficiency of a user's ability to find health care related data while also improving the quality of care to individual patients. Users may be physicians, nurses, and administrators accessing patient-related information and relaying real-time information as patient data changes or patient data does not comply with defined rules, as set by the physicians, nurses, or administrators. Users access the present invention as shown in FIGS. 1-8. The data index used by the present invention is derived from identifying, classifying, and storing patient medical data from multiple EHR systems across multiple networks and platforms. Leveraging the capabilities of a fully-integrated HIE solution, providers are notified earlier in the healthcare encounter of information provided at the point-of-care when a patient presents for a specific service. This allows the provider to refer to appropriate care management and disease management programs based on the information they are viewing, as well as supporting appropriate interventions, education and follow-up in a real-time manner. This improved HIE process is essential to reducing the ensuing data chaos caused by disparate EHR systems, ensuring that gaps in care are addressed while the patient is actually in front of the provider using the system, rather than after the patient has left, and providing a definitive source of information and custom reports, as well as being flexible enough to comb the clinical and administrative data from multiple EHRs to provide timely information and aggregate patient data, that leads to evidence-based care, increased quality of outcomes and a better healthcare experience overall, which corresponds to the overall goals and objectives of an ACO and other healthcare organizations that hope to reduce costs and improve care.

The system and method of the present invention provides physicians, nurses, or administrators with a uniform way to digest electronic patient data across multiple platforms, and establish rule-based criteria which can alter the course of treatment provided by physicians, nurses, or administrators to prevent any drop in patient care quality or index, as periodically defined by those users. The present invention provides for the efficient flow of clinically relevant information across multiple EHR platforms through the use of data aggregation, rule-based sets, and real-time user entry of patient data. The system and method of the present invention also solves the problem associated with relative inaccessibility of patient data caused by storing large amounts of patient data across multiple platforms in various locations that may be inaccessible from other platforms or incompatible with other patient data previously gathered.

In a preferred embodiment, the system and method of the present invention periodically accesses the native clinical data associated with a patient on multiple EHR platforms through the use of a WAN, LAN or Internet. The system then decodes, analyzes, indexes and stores the aggregate patient data into a centralized database for real-time serving to physicians, nurses, or administrators for general use by physicians, nurses, or administrators on their local computer or for rule based processing for improving a lower standard of patient care.

### OBJECTS OF THE INVENTION

The primary objective of this invention is to coordinate patient care across various platforms and EHR systems by aggregating health information for a master patient index, and health information exchange.

Another objective of this invention is to provide real-time, up-to-date medical information derived from aggregate patient data, for patients at a point of care during the patient visit while bypassing formal application programming interfaces or software development kits.

Another objective of this invention is to analyze current data from multiple platforms to provide instantaneous alerts to medical providers regarding gaps in care while being treated and before a patient has left the point of case

Another objective of this invention is to gather, normalize, and link patient data from across multiple platforms in order to store and analyze said data for future use.

Another objective of this invention is to store and deliver patient data from multiple platforms to medical providers in electronic or digital envelopes.

Another objective of this invention is to prospectively monitor patients and advise caregivers of gaps in care and the proposed resolution of that gap based on established rules of care and medical treatment.

### BRIEF DESCRIPTION OF DRAWINGS

FIG. 1 is a block diagram of a Patient specific alert process flow;

Ref. 1 is the starting point or beginning of the patient specific alert process;

Ref. 2 shows the user sign-in point;

Ref. 3 shows the user looking up patient information;

Ref. 4 shows the alert agent detecting patient and physician content, which is forwarded to the alert broker;

Ref. 5 shows receipt of user and patient context;

Ref. 6 shows the alert broker searching for alerts;

Ref. 7 presents an option of continuing for additional alerts;

Ref. 8 shows the end of the process in the absence of additional alerts;

Ref. 9 is the prioritization of the alerts;

Ref. 10 shows the systems searching for the highest priority alert;

Ref. 11 shows the modification of the icon for the proper alert;

Ref. 12 is the physician user choosing a particular icon;

Ref. 13 shows the system presenting various alerts to the physician user;

Ref. 14 is the physician user acting based on information obtained from alerts;

Ref. 15 is the physician user marking particular alerts as handled;

Ref. 16 is the end of the specific alert process;

FIG. 2 is a block diagram of Physician/User specific alert process flow;

Ref. 17 is the starting point or beginning of the physician user specific alert process;

Ref. 18 shows the user sign-in point;

Ref. 19 shows the alert agent detecting patient and physician content, which is forwarded to the alert broker;

Ref. 20 shows receipt of user context;

Ref. 21 shows the alert broker searching for alerts;

Ref. 22 presents an option of continuing for additional alerts;

Ref. 23 shows the end of the process in the absence of additional alerts;

Ref. 24 is the prioritization of the alerts;

Ref. 25 shows the systems searching for the highest priority alert;

Ref. 26 shows the modification of the icon for the proper alert;

Ref. 27 is the physician user choosing a particular icon;

Ref. 28 shows the system presenting various alerts to the physician user;

Ref. 29 is the physician user acting based on information obtained from alerts;

Ref. 30 is the physician user marking particular alerts as handled;

Ref. 31 is the end of the specific alert process;

Ref. 32 shows the wait loop for a predefined interval of time;

FIG. 3 is a block diagram of “Red Envelope”—gap in care process example;

Ref. 33 shows the user sign-in point, at EMR;

Ref. 34 shows the user looking up patient clinical information;

Ref. 35 is the alert agent detecting user and patient identity;

Ref. 36 is the alert broker receiving request for alert for physician and patient;

Ref. 37 is the alert broker sending gap in care alerts for an ailment;

Ref. 38 is the alert agent receiving the gap in care alert and changing icon to RED;

Ref. 39 is the user seeing the alert and clicking the notification icon;

Ref. 40 is the alert agent presenting user with alert specifics;

Ref. 41 is the user assessing gaps in care and ordering treatment or test previously neglected;

Ref. 42 is the user acknowledging gap in care and entering resolution status;

Ref. 43 is the alert agent capturing and storing the resolution for future reference;

FIG. 4 is a block diagram of “Green Envelope” no gap in care for other alert) example;

Ref. 44 shows the user sign-in point at EMR;

Ref. 45 shows the user looking up patient clinical information;

Ref. 46 is the alert agent detecting user and patient identity;

Ref. 47 is the alert broker receiving request for alert for physician and patient;

Ref. 48 is the alert broker sending all clear alert;

Ref. 49 is the alert agent receiving the all clear alert and changing icon to GREEN;

Ref. 50 is the user seeing the alert and clicking the notification icon;

Ref. 51 is the using acknowledging all clear alert and proceeding with normal care;

FIG. 5 is a block diagram of “Orange Envelope”—physician notification example;

Ref. 52 shows the user sign-in point at EMR;

Ref. 53 is the alert agent detecting user and patient identity;

Ref. 54 is the alert agent makes request to check notifications every N minutes;

Ref. 55 is the alert broker receiving request for alerts for physician;

Ref. 56 is the system checking for new alerts before proceeding;

Ref. 57 is the alert broker sending a notification, alert;

Ref. 58 is the alert agent receiving the notification alert and changing icon to ORANGE

Ref. 59 is the user seeing the alert and clicking the notification icon;

Ref. 60 is the using receiving notification and proceeding with normal care;

FIG. 6 is a block diagram of “Purple Envelope”—AGO consent alert example;

Ref. 61 shows the user sign-in point at EMR;

Ref. 62 shows the user looking up patient clinical information;

Ref. 63 is the alert agent detecting user and patient identity;

Ref. 64 is the alert broker receiving request for alerts from physician and patient;

Ref. 65 is the alert broker sending ACO consent for patient;

Ref. 66 is the alert agent receiving the AGO consent alert and changing icon to PURPLE;

Ref. 67 is the user seeing the alert and clicking the notification icon;

Ref. 68 is the alert agent presenting user with consent forms;

Ref. 69 shows user counseling patient about benefits of sharing information;

Ref. 70 shows the use acknowledging consent counseling and closing alert;

Ref. 71 is the alert agent capturing patient counseling on consent and storing for future reference;

FIG. 7 is a block diagram of “Blue Envelope”—Discharge instruction alert example;

Ref. 72 shows the user sign-in point at EMR;

Ref. 73 shows the user looking up patient clinical information;

Ref. 74 is the alert agent detecting user and patient identity;

Ref. 75 is the alert broker receiving request for alerts for physician and patient;

Ref. 76 is the alert broker sending discharge instructions for patient care post discharge;

Ref. 77 is the alert agent receiving the informational alert and changing icon to BLUE;

Ref. 78 is the user seeing the alert and clicking the notification icon;

Ref. 79 is the alert agent presenting user with discharge instructions;

Ref. 80 shows user reviewing discharge instructions;

Ref. 81 shows the user acknowledging receipt of discharge instructions;

Ref. 82 is the alert agent capturing receipt of discharge instructions and storing for future reference;

FIG. 8 is a block diagram of Architectural diagram of overall system;

Ref. 83 is MIDS/HIE;

Ref. 84 is the alert broker;

Ref. 85 is alert agent working with an EMR;

Ref. 86 is alert agent working with an EHR;

Ref. 87 is alert agent working with an HIS;

### DETAILED DESCRIPTION OF DRAWINGS

While the above description is of the preferred embodiment of the present invention, it should be appreciated that the invention may be modified, altered, or varied without deviating from the scope and fair meaning of the following claims.

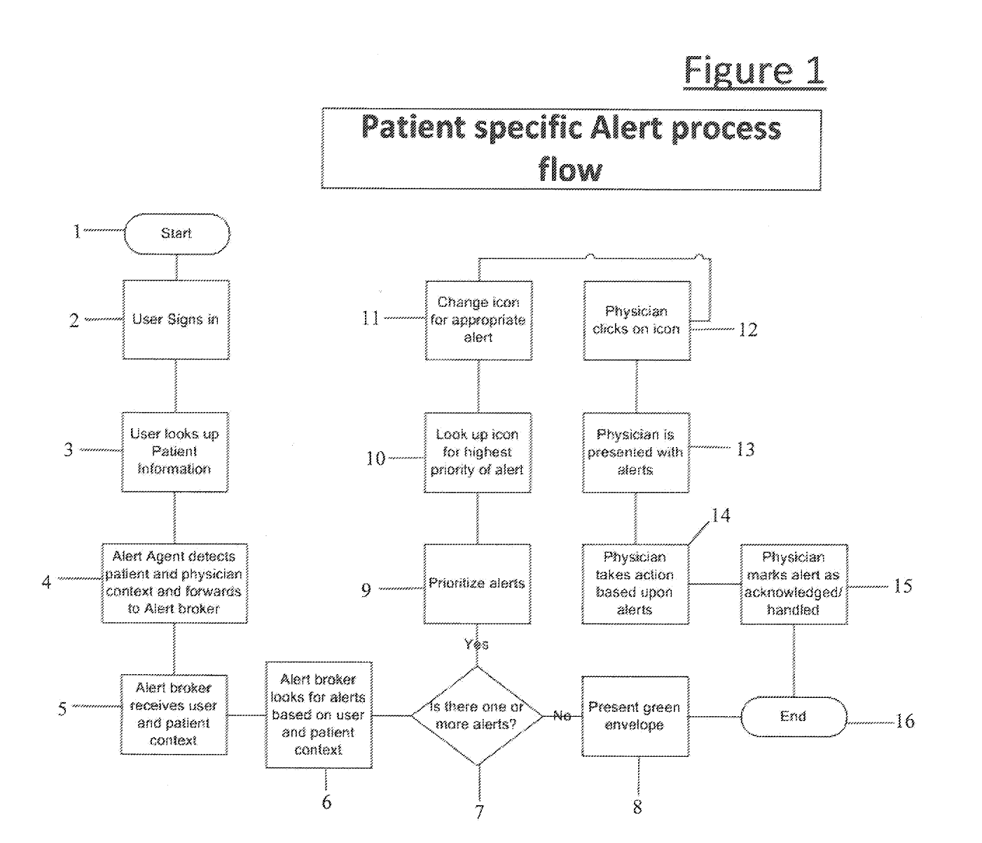

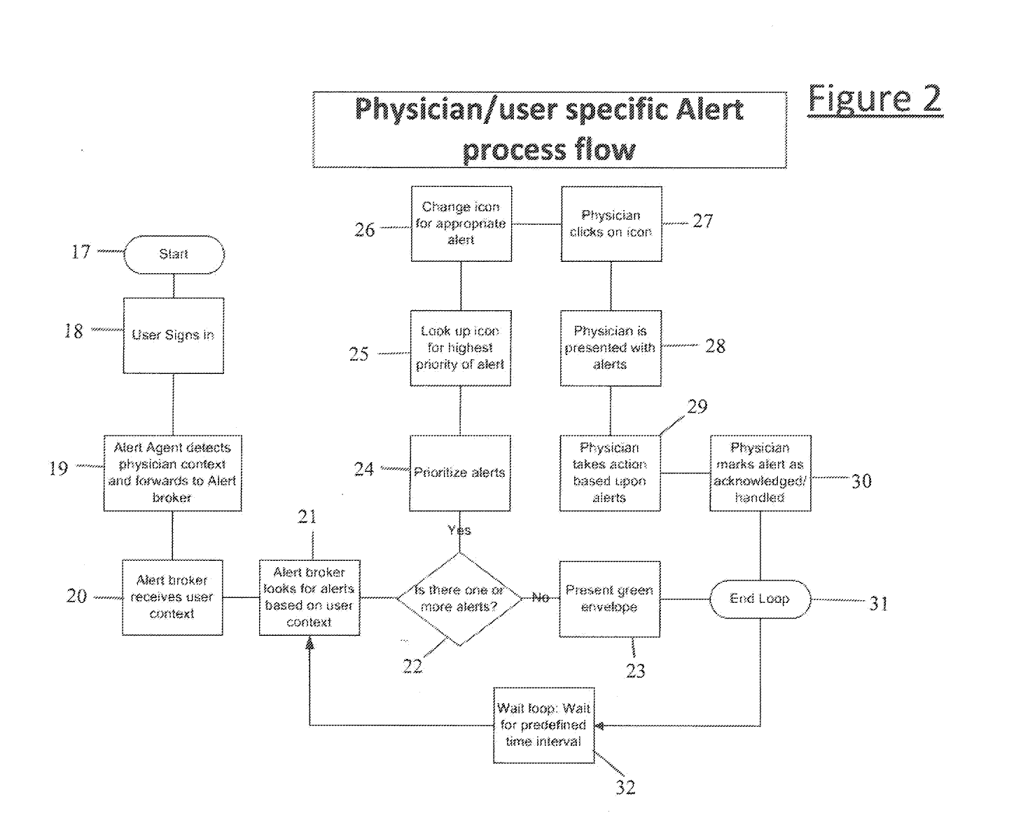

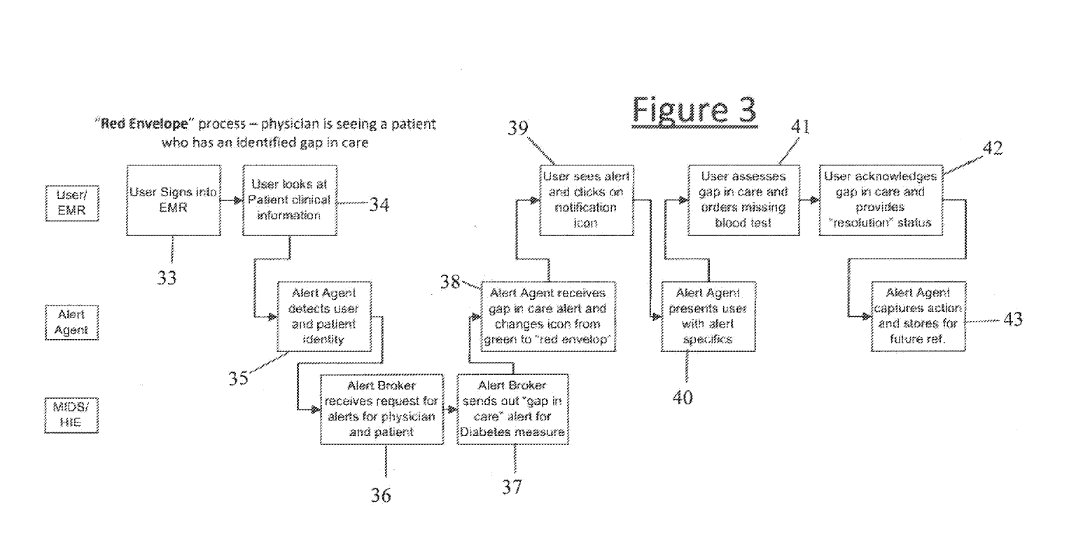

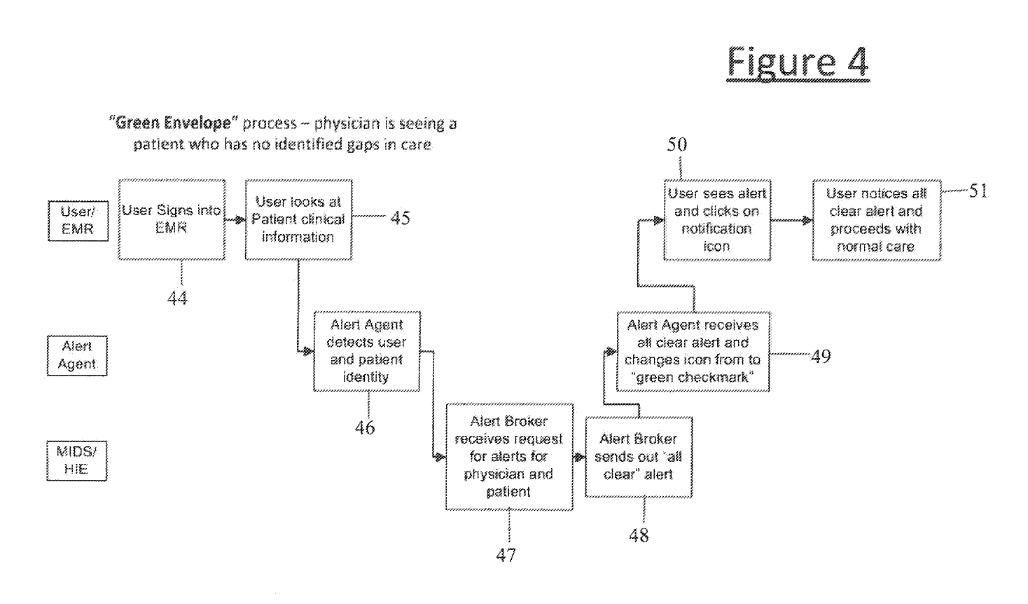

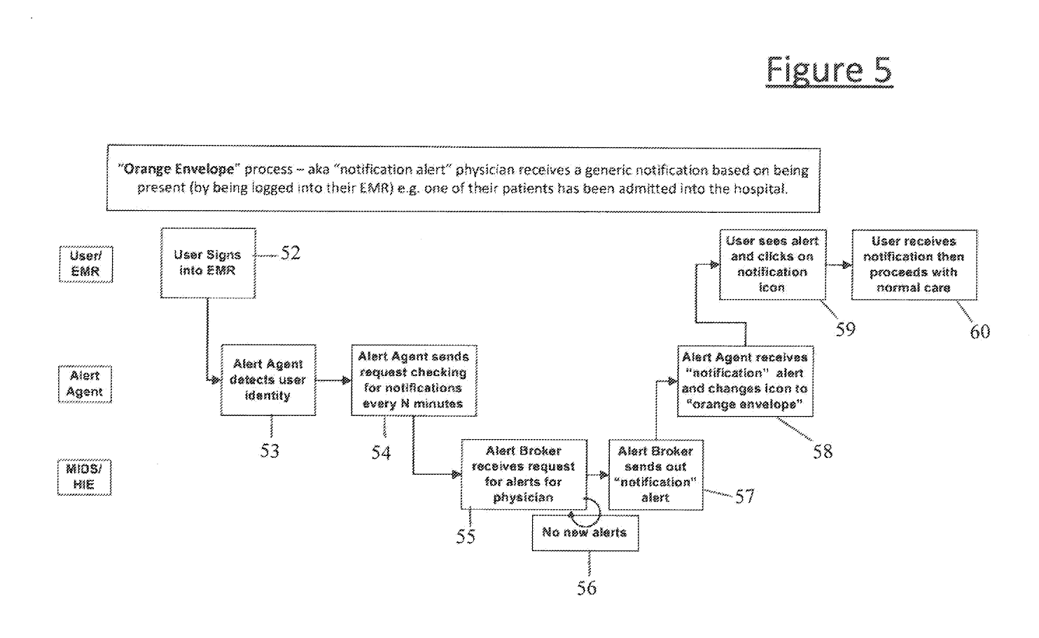

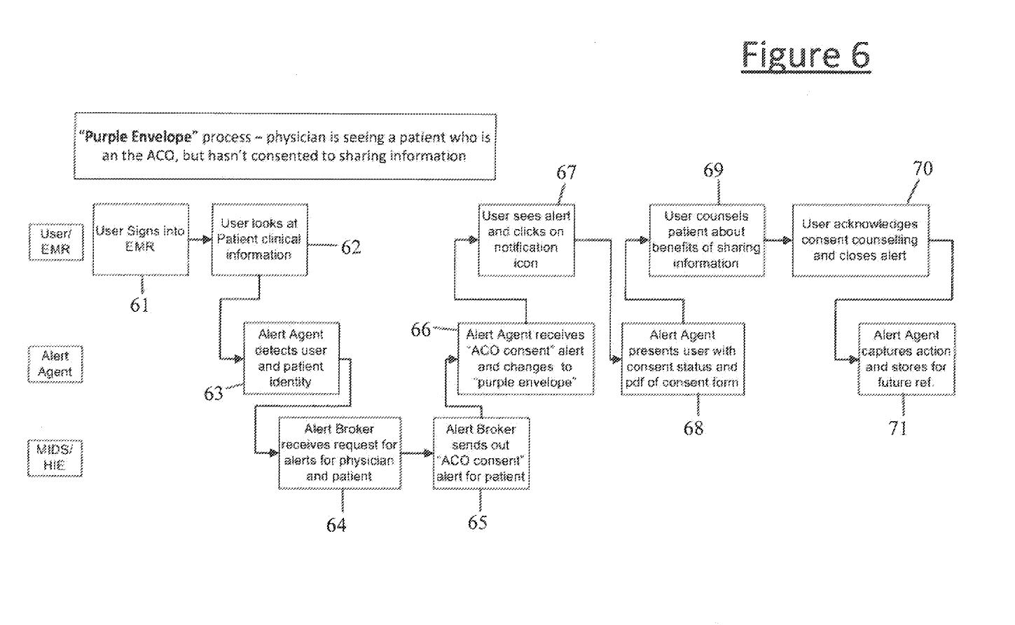

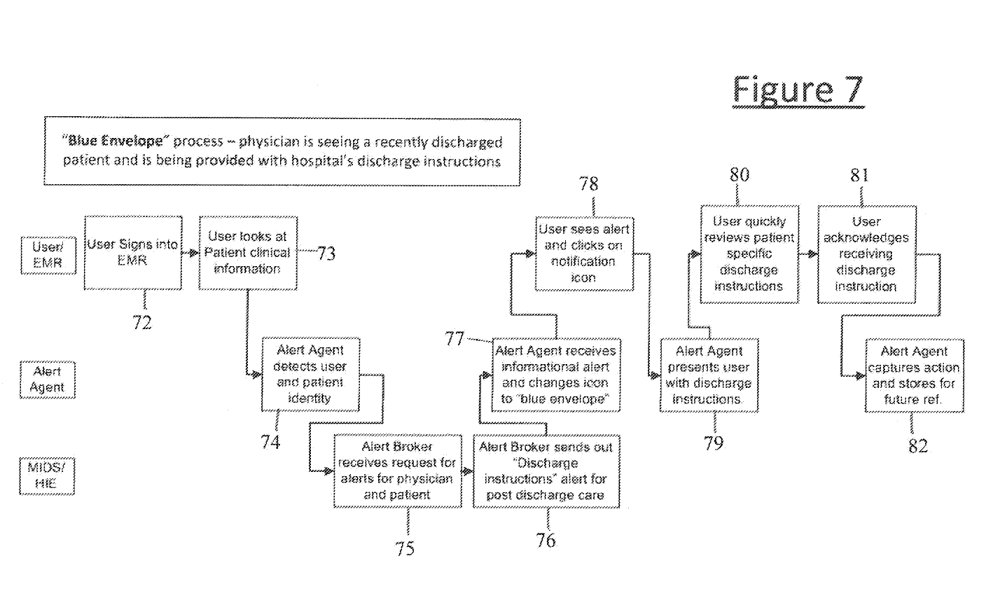

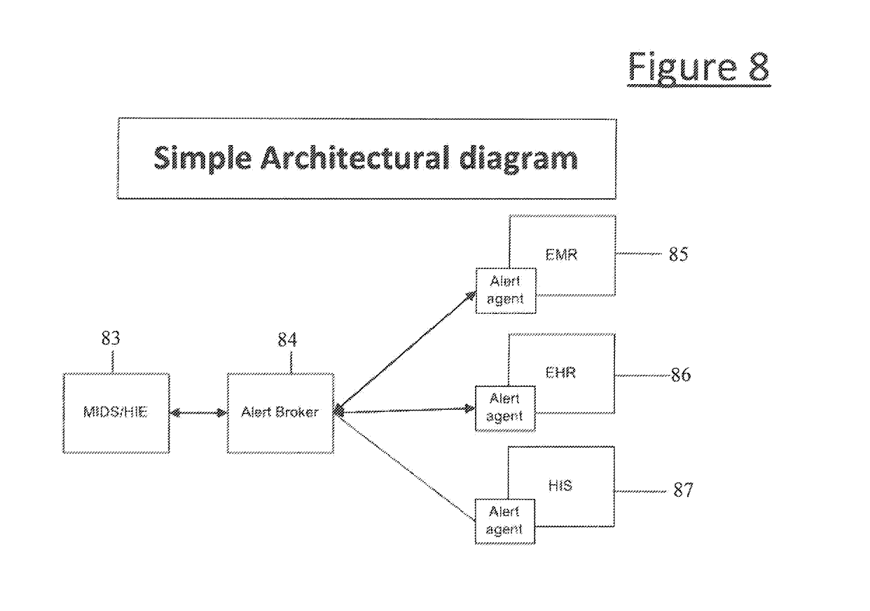

Referring generally to FIGS. 1-8, the Method for Indexing, Searching and Retrieving Health information by enabling various users to locate and search patient information, medical records, physician records, laboratory reports, summaries, notes and related medical data from multiple EHR systems that are not compatible or the same.

FIG. 1 shows a patient specific alert process flow. Initially, a user signs in to his/her platform at the point of care. The user looks up the patient information within the user platform using the check in information provided by the patient. The alert agent detects/notes the patient context and physician context and forwards those identities to the alert broker. The alert broker then receives the user context and the patient context and looks for the alerts based on the user context and patient context. If there is no alert, the green envelope is presented to the user indicating that the user should proceed and there are no pending alerts. If there is one or more alert, the system will prioritize the pending alerts based on community based configurable priority schedules. The system will handle each alert individually and in order of priority. The system will look up the icon for the highest priority of alert and change the icon for the appropriate alert. Once the physician clicks on the icon, the physician will be presented with the alert. The physician will take the action(s) indicated by the alert and then mark the alert as acknowledged or handled. The process will continue for the remaining alerts until all pending alerts are handled and marked as such.

FIG. 2 shows a physician/user specific alert process flow. Initially, a user signs in to his/her platform at the point of care. The alert agent detects/notes the physician context and forwards to the alert broker. The alert broker then receives the user context and looks for the alerts based on the user context and patient context. If there is no alert, the green envelope is presented to the user indicating that the user should proceed and there are no pending alerts. If there is one or more alert, the system will prioritize the pending alerts based on community based, configurable priority schedules. The system will handle each alert individually and in order of priority. The system will look up the icon for the highest priority of alert and change the icon for the appropriate alert. Once the physician clicks on the icon, the physician will be presented with the alert. The physician will take the action(s) indicated by the alert and then mark the alert as acknowledged or handled. The process will continue for the remaining alerts until all pending alerts are handled and marked as such. A wait loop holds the system in wait mode for a predefined time interval (such as 5 minutes or 15 minutes) and then directs the alert broker to look for alerts based on user context.

FIG. 3 shows the process of a physician seeing a patient with an identified gap in care (or a red envelope in this embodiment). Initially, a user signs into an EMR and looks at patient clinical information for a particular patient. The alert agent detects the user identity and the patient identity. The alert broker then receives a request for pending alerts linked to the user/physician and the patient. Based on the pending alerts, alert broker sends out a “gap in care” alert for a particular ailment (i.e. diabetes in this example). The alert agent receives notice of a gap in care and changes the icon from green envelope to red envelope to alert the user to the issue requiring the user's attention. The red envelope will be displayed on the user's platform where the user should see the alert and click on the notification icon at which point the alert agent presents the user with the alert specifics. The user will assess the gap in care and take action to resolve the gap in care (i.e. ordering blood test in this example). The user will then acknowledge the gap in care and provide a resolution status to the digital envelope via the interactive form. The alert agent captures this action and stores for future reference and distributes this action within the community network, including the physicians native EMR.

FIG. 4 shows the process of a physician seeing a patient with no identified gap in care (or a green envelope in this embodiment). Initially, a user signs into an EMR and looks at patient clinical information for a particular patient. The alert agent detects the user identity and the patient identity. The alert broker then receives a request for pending alerts linked to the user/physician and the patient. If there are not pending alerts, the alert broker will issue an all clear alert. The alert agent will receives this all clear alert and changes the icon displayed on the user platform to green (i.e. green checkmark in this embodiment). Once the user sees this alert on his or her platform, the user will be guided to click on the notification icon at which point the user will receive the all clear alert and proceed with normal care.

FIG. 5 shows the process of a physician receiving a generic notification based on being logged into the physician EMR (or an orange envelope in this embodiment). Initially, a user signs into an EMR and looks at patient clinical information for a particular patient. The alert agent detects the user identity. The alert agent sends a request checking for notification every N minutes (number of N to be determined by administrator). The alert broker then receives a request for pending alerts linked to the user/physician. If there are not pending alerts, the alert broker will continue to check again for requests until requests are detected. If there are pending requests, the alert broker will send a “notification alert.” Once the alert agent receives the notification alert, the icon displayed on the user's platform will change to orange envelope. Once the user sees this alert on his or her platform, the user will be guided to click on the notification icon at which point the user will receive the notification and may proceed with normal care.

FIG. 6 shows a physician seeing a patient of an Accountable Care Organization (ACO) but has not provided patient consent to share information (or a purple envelope in this embodiment). Initially, a user signs into an EMR and looks at patient clinical information for a particular patient. The alert agent detects the user identity and the patient identity. The alert broker then receives a request for pending alerts linked to the user/physician and the patient. Based on the pending alerts, alert broker sends Out an “ACO consent” alert for a particular ailment (i.e. diabetes in this example). The alert agent receives notice of an ACO consent and changes the icon to purple envelope to alert the user to the issue requiring the user's attention. The purple envelope will be displayed on the user's platform where the user should see the alert and click on the notification icon at which point the alert agent presents the user with the consent status and a pdf of the consent form. The user will counsel the patient on the benefits of consenting to the sharing of information. The user will then acknowledge the consent counseling and close the alert. The alert agent captures this action and stores for future reference.

FIG. 7 shows a physician seeing a recently discharged patient and providing discharge instructions to that patient (or a blue envelope in this embodiment). Initially, a user signs into an EMR and looks at patient clinical information for a particular patient. The alert agent detects the user identity and the patient identity. The alert broker then receives a request for pending alerts linked to the user/physician and the patient. Based on the pending alerts, alert broker sends out a “Discharge Instructions” alert for a post discharge care. The alert agent receives an informational alert and changes the icon to blue envelope to alert the user to the issue requiring the user's attention. The blue envelope will be displayed on the user's platform where the user should see the alert and click on the notification icon at which point the alert agent presents the user with the patient discharge instructions and user quickly reviews the patient specific discharge instructions. The user will then acknowledge receiving the discharge instruction and close the alert. The alert agent captures this action and stores for future reference.

FIG. 8 shows how the present system can support the same workflow and delivery pattern for an EMR, HER, or HIS, Medical information is exchanged bi-directionally (or on a full duplex channel) between the MIDS/HIE (or data warehouse) and the Alert Broker. The MIDS/HIE collects data from community resources outside of the user's local platform without the need for integration or login. The community data (or supplemental data from sources outside the user's local platform) is collected and normalized so that it may be combined and displayed with data from local and outside platforms from sources throughout the community. The normalized data is constantly updated and typically available in real time as soon as a user signs into that user's local platform and links to a particular patient. As the user moves throughout the platform and makes notes or modifies patient medical information, this new patient data is collected by the MIDS/HIE in order to maintain accurate and constantly up to date patient medical information.

Alerts may be determined by comparison of patient data and EHR with recognized standards of patient care and medical rule sets designating proper care and treatment of various disorders and maladies. If the Alert Agent detects a local request for specific patient information within the local EMR (or local platform) and the periodic analysis of the data within the data warehouse indicates there is an alert for that patient, the alert broker sends an alert message to the alert agent adjacent to the EHR to provide a visual cue that an alert is present (in this case by changing the color of the digital envelope to red). If Alert Agent detects a local request for specific patient information within the local EMR and the periodic analysis of the data within the data warehouse indicates there is not an alert for that patient, the alert broker sends an alert to the alert agent adjacent to the EMR to provide an “all clear” visual cue (in this embodiment, a change digital envelope icon to include a green check mark).

What is claimed:

1. A computer implemented medical information system for creating real-time, comprehensive electronic health records assembled from multiple platforms, comprising:
a display device for a user;
a data collection system;
a data normalization system;
a data analysis system;
a data management system, and
a database for storage of said electronic health records.

2. The medical information system of claim 1, wherein said medical information system identifies a user of a local platform, wherein said medical information system identifies a patient electronic health record, wherein said medical information system links said user and said patient whenever said user accesses said medical information system.

3. The medical information system of claim 2, where said data flows along a full duplex channel allowing simultaneous communication in both directions between an outside platform electronic health record and said database.

4. The medical information system of claim 3, wherein said data collection system stores data from said outside platform electronic health record in said database, said data collection system supplementing said database with supplemental data from at least one outside platform, wherein said supplemental data is available to said medical information system without any user log in at said outside platform, wherein said data collection system stores and displays in real-time updated data within said medical information system.

5. The medical information system of claim 4, wherein said supplemental data is any data not originally contained within said local platform.

6. The medical information system of claim 5, wherein said data normalization system converts said supplemental data to a standardized format, wherein said supplemental data in a standardized format is catalogued in said database, wherein said data normalization system notifies said user of the presence of supplemental data not viewed by said user.

7. The medical information system of claim 6, wherein said data analysis system utilizes an alert provider, wherein said alert provider is coupled to said database on a full duplex channel, wherein said alert provider is coupled to a local platform on a full duplex channel, such that said alert provider is viewable within said local platform at the time said user accesses said medical information system.

8. The medical information system of claim 7, wherein said alert provider displays an icon within said platform while allowing said platform to remain fully functional, wherein said alert provider collects and submits said data without repeated or further permission or login of said user into said alert provider system, wherein said supplemental data is available to said medical information system without integration between said outside platform and said medical information system.

9. The medical information system of claim 8, wherein said alert provider compares said data to a medical rule set, wherein said alert provider identifies areas of concern in said medical health record based on divergence of said medical health record from said medical rule set, wherein said medical information system produces a user questionnaire seeking user input regarding patient and advising said user on proper treatment for said patient.

10. The medical information system of claim 9, wherein said data management system compares said data to said medical rule set to identify gaps in patient care, wherein said data management system generates a patient-specific task list based on said gaps in care said user's patient notes.

11. The medical information system of claim 10, wherein said user questionnaire receives input from said user, wherein said questionnaire tailors later inquiries based on prior user input, wherein said alert provider delivers said input to said database updating aggregated patient data.

12. The medical information system of claim 1 wherein said display device is selected from the group consisting of: desk top computer, laptop, cellular telephone, tablet, handheld personal device, electronic display device.

13. The medical information system of claim 8, wherein said medical rule set is selected from the group consisting of: community defined rules, public health standards, industry standard medical guidelines, insurance company requirements, at risk contract requirements, commercial quality control measures or standards, and Medicare/Medicaid.
